(19) United States
(12) Patent Application Publication
(10) Pub. No.: US 2023/0385812 A1
(43) Pub. Date: Nov. 30, 2023

(54) CRYPTOCURRENCY ASSET BACKED BY A PRECIOUS METAL

(71) Applicant: Johnathan Taedoo Chae, Smyma, GA (US)

(72) Inventor: Johnathan Taedoo Chae, Smyma, GA (US)

(21) Appl. No.: 17/828,976

(22) Filed: May 31, 2022

(51) Int. Cl. G06Q 20/36; G06Q 20/38; G06Q 20/40

(52) U.S. Cl. CPC G06Q 20/3678; G06Q 20/389; G06Q 20/401

(57) ABSTRACT

One example embodiment comprises a physical asset including at least one precious-metal provided in a small quantity in the range of 1/25th of an ounce to 1/10,000th of an ounce, wherein the physical asset is associated with a digital asset. In some embodiments, the digital asset is cryptocurrency stablecoin.

### BACKGROUND

Many existing cryptocurrencies are provided in digital form only. However, a few cryptocurrencies are backed by physical or stable assets called “stablecoins.” It is typically difficult and inconvenient to convert stablecoins into their associated asset. The physical counterpart of the asset is held by a third-party custodian. Asset owners must trust the custodian to properly track and maintain the asset. This defeats a primary benefit of cryptocurrency, which is to have a trustless decentralized system.

PAX Gold (PaxG) is gold-backed stablecoin where a single token represents one fine troy ounce of a London Good Delivery gold bar, stored in a professional vault. Each gold bar weighs approximately 400 ounces. Accordingly, the minimum amount of cryptocurrency that is required to take possession of the physical gold is about $700,000. This is an impractical sum for the average investor, thereby making it impractical to take possession of the physical gold unless one is a high-net-worth individual or institutional investor.

### SUMMARY

One example embodiment comprises a physical asset associated with a digital asset. The physical asset includes at least one precious-metal, wherein the at least one precious metal is provided in a small quantity in the range of 1/25^{th} of an ounce to 1/10,000^{th} of an ounce. In some embodiments, the digital asset is cryptocurrency stablecoin.

Another example embodiment comprises a physical coin or note configured to provide a cryptocurrency stablecoin asset. The coin or note comprises at least one core layer comprised of wood, metal, plastic, or any of various combinations thereof; at least one inner layer comprised of a thin sheet of a precious metal; and an outer shell comprised of a transparent material; wherein a layer of the at least one inner layer adjoins a layer of the at least one core layer; wherein the at least one core layer includes a slit, a pocket, a compartment or a void into which a flexible RF Identification (RFID) tag is placed; and wherein the RFID tag includes a Non-Fungible Token (NFT)-encrypted chip.

In some embodiments, the NFT-encrypted chip includes encoded identification information for generating and storing a unique NFT that is associated with the coin and configured for authenticating the coin.

In some embodiments, at least a portion of the outer shell is comprised of a clear acrylic material. In some embodiments, at least a portion of the precious metal comprises gold, silver, platinum, palladium, or any of various combinations thereof.

According to a further example embodiment, the physical coin or note and the unique NFT associated with the physical coin are convertible to a digital coin token. Upon conversion, the NFT associated with the physical coin is destroyed or disabled.

According to a further example embodiment, the digital coin token is convertible to the physical coin or note and the unique NFT associated with the coin or note. Upon conversion, the digital coin token is destroyed, disabled or deleted.

In some embodiments, the at least one core layer is made of Nickel, Aluminum, or any other metal, with an underplating of Nickel. In some embodiments, at least one surface of the at least one core layer is provided with a raised surface portraying artwork. In some embodiments, the raised surface portraying artwork is provided prior to covering the at least one core layer with the at least one inner layer. In some embodiments, after the at least one inner layer covers the raised surface portraying artwork on the at least one core layer, the at least one inner layer and the at least one core layer are embedded in a solid and clear acrylic that takes on the shape of a coin or note.

Another example embodiment comprises associating a digital asset with a physical asset that includes at least one precious-metal, wherein the at least one precious metal is provided in a small quantity in the range of 1/25th of an ounce to 1/10,000th of an ounce. In some embodiments, the digital asset is cryptocurrency stablecoin.

Another example embodiment comprises a method for providing a cryptocurrency stablecoin asset. The method includes providing at least one core layer comprised of wood, metal, plastic, or any of various combinations thereof; wherein the at least one core layer includes a slit, a pocket, a compartment or a void; placing a flexible RF Identification (RFID) tag into the slit, the pocket, the compartment, or the void; wherein the RFID tag includes a Non-Fungible Token (NFT)-encrypted chip; providing at least one inner layer comprised of a thin sheet of a precious metal; and providing an outer shell comprised of a transparent material; wherein a layer of the at least one inner layer adjoins a layer of the at least one core layer; and at least partially enclosing or surrounding the at least one core layer and the at least one inner layer with the outer shell to form a physical coin or note.

In some embodiments, the method further comprises storing encoded identification information on the NFT-encrypted chip, the encoded identification information configured for generating and storing a unique NFT that is associated with the coin and configured for authenticating the coin or note.

In some embodiments, the method further comprises providing at least a portion of the outer shell using a clear acrylic material. In some embodiments, the method further comprises providing at least a portion of the precious metal using gold, silver, platinum, palladium, or any of various combinations thereof.

According to a further example embodiment, the method comprises converting the physical coin or note and the unique NFT associated with the physical coin or note to a digital coin token. Upon conversion, the NFT associated with the physical coin is destroyed or disabled.

According to a further example embodiment, the method comprises converting the digital coin token to the physical coin or note and the unique NFT associated with the physical coin or note. Upon conversion, the digital coin token is destroyed, disabled or deleted.

In some embodiments, the method comprises providing the at least one core layer using Nickel, Aluminum, or any other metal, with an underplating of Nickel. In some embodiments, the method comprises providing at least one surface of the at least one core layer with a raised surface portraying artwork. In some embodiments, the method comprises providing the raised surface portraying artwork prior to covering the at least one core layer with the at least one inner layer. In some embodiments, after the at least one inner layer covers the raised surface portraying artwork on the at least one core layer, the method comprises embedding at least one inner layer and the at least one core layer in a solid and clear acrylic that takes on the shape of a coin or note.

### BRIEF DESCRIPTION OF THE DRAWINGS

FIG. 1 is a side view of a physical coin or note configured to provide a cryptocurrency stablecoin asset, according to example embodiments.

FIG. 2 illustrates a flow diagram of a method for providing a cryptocurrency stablecoin asset, according to example embodiments.

FIG. 3 illustrates a flow diagram of a method for converting the cryptocurrency stablecoin asset to a digital coin token, according to a further set of embodiments.

FIG. 4 illustrates a flow diagram of a method for converting a digital coin token to the cryptocurrency stablecoin asset, according to a further set of embodiments.

FIG. 5 illustrates an example computer system architecture which may be used to implement any of the above-described methods.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, computer readable storage medium and system, as represented in the attached figures, is not intended to limit the scope of the application as claimed but is merely representative of selected embodiments. Multiple embodiments depicted herein are not intended to limit the scope of the solution. The computer-readable storage medium may be a non-transitory computer readable medium or a non-transitory computer readable storage medium.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one example. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments. In the diagrams, any connection between elements can permit one-way and/or two-way communication even if the depicted connection is a one-way or two-way arrow.

Data shared and received may be stored in a database, which maintains data in one single database (e.g., database server) and generally at one particular location. This location is often a central computer, for example, a desktop central processing unit (CPU), a server CPU, or a mainframe computer. Information stored on a centralized database is typically accessible from multiple different points. A centralized database is easy to manage, maintain, and control, especially for purposes of security because of its single location. Within a centralized database, data redundancy is minimized as a single storing place of all data also implies that a given set of data only has one primary record. A blockchain may be used for storing transport-related data and transactions.

Any of the actions described herein may be performed by one or more processors (such as a microprocessor, a sensor, an Electronic Control Unit (ECU), a head unit, or the like). The one or more processors may communicate with other processors. The one or more processors and the other processors can send data, receive data, and utilize this data to perform one or more of the actions described or depicted herein.

In some embodiments, the instant solution is a physical asset comprising at least one precious-metal provided in a small quantity in the range of 1/25th of an ounce to 1/10,000th of an ounce, wherein the physical asset is associated with a digital asset. In some embodiments, the digital asset is cryptocurrency stablecoin.

In some embodiments, the instant solution is a method comprising associating a digital asset with a physical asset that includes at least one precious-metal, and providing the at least one precious metal in a small quantity in the range of 1/25th of an ounce to 1/10,000th of an ounce. In some embodiments, the method further comprises providing the digital asset as a cryptocurrency stablecoin.

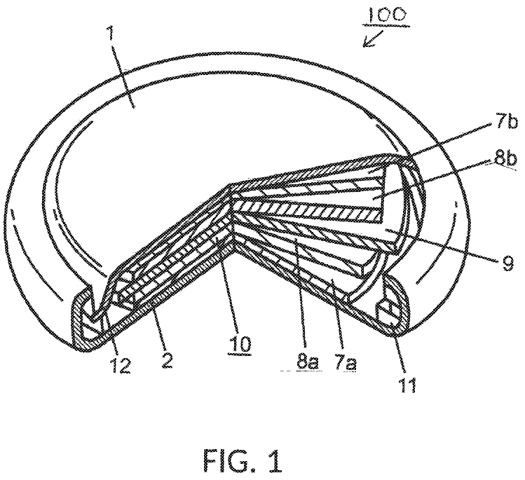

FIG. 1 is a side view of a physical coin or note 100 (such as an Aurum® note or goldback) configured to provide a cryptocurrency stablecoin asset, according to example embodiments. For example, the Aurum® note has the approximate form factor of conventional paper currency, but it functions as a modern vehicle for gold investment. Each Aurum® note contains a precise thin microlayer of 24 karat gold protected by additional thin layers of durable polymer. Although the Aurum® note currently includes only a gold bullion version, in some embodiments, a platinum version, a silver bullion version, a palladium version, and/or an alloy version combining any of the above may be provided.

Referring to FIG. 1, the physical coin or note 100 include at least one core layer. In the illustrated embodiment, the at least one core layer includes a first core layer 8a comprised of wood, metal or plastic, and a second core layer 8b comprised of wood, metal or plastic. The first and second core layers 8a, 8b form a slit, pocket, compartment or void into which a flexible RF Identification (RFID) tag 9 is placed. The RFID tag 9 includes a Non-Fungible Token (NFT)-encrypted chip. The NFT-encrypted chip includes encoded identification information for generating and storing a unique NFT that is associated with the physical coin and configured for authenticating the physical coin.

In an alternative embodiment, the at least one core layer comprises a single layer of wood, metal, or plastic. Pursuant to this alternative embodiment, a pocket or a void is formed within the single layer of wood, metal, or plastic into which the flexible RFID tag 9 is placed

One illustrative example of a suitable RFID tag 9 including an NFT-encrypted chip is called a FlexIC, offered by PragmatIC Semiconductor, 400 Cambridge Science Park, Milton Road, Cambridge CB4 0WH, United Kingdom. Another illustrative example is the flexible Micro NFC/RFID transponder NTAG203 with Antenna, available from Adafruit, 150 Varick Street, New York City, NY 10013. Yet another example is the Anti-Metal NFC Tab available from Shanghai HuaYuan Electronic Co., Ltd., 517 Room Building B, 399 Hengnan Road, Rongjin Pujiang Science Park, Shanghai 201112 China.

In addition to the at least one core layer, the physical coin or note 100 includes at least one inner layer. In the illustrated embodiment, the at least one inner layer includes a first inner layer 7a comprised of a thin sheet of a precious metal such as silver, gold, platinum, a precious metal alloy, or any of various combinations thereof, and a second inner layer 7b comprised of a thin sheet of a precious metal such as silver, gold, platinum, a precious metal alloy, or any of various combinations thereof. However, in an alternative embodiment, the at least one inner layer comprises a single layer comprised of the thin sheet of the precious metal or the precious metal alloy. A layer of the at least one inner layer adjoins a layer of the at least one core layer. For example, in the present embodiment, the first core layer 8a adjoins the first inner layer 7a, and the second core layer 8b adjoins the second inner layer 7b. In some embodiments, the at least one inner layer comprises a very small quantity of precious metal. In some embodiments, the very small quantity is 1/100^{th} of an ounce, or 1/1000^{th} of an ounce, or 1/5000^{th} of an ounce, for example.

The physical coin or note 100 includes an outer shell that is at least partially transparent. In the illustrated embodiment, the outer shell includes an upper clamshell portion 1 and a lower clamshell portion 2. At least one of the upper clamshell portion 1 or the lower clamshell portion 2 are fabricated of clear acrylic. In some embodiments, at least a portion of the outer shell is fabricated of a transparent material. In some embodiments, glue, a thermal adhesive, or another type of adhesive may be used to seal the upper clamshell portion 1 to the lower clamshell portion 2. Pursuant to an alternative embodiment, the outer shell is fabricated by flowing a heated acrylic material in a liquid state so as to partially or completely encase or enclose the at least one inner layer together with the at least one core layer. After the heated acrylic material cools down to approximately room temperature, the acrylic material is transformed to a solid or semi-solid state. Pursuant to another alternative embodiment, the outer shell is fabricated of glass, tempered glass, or plexiglass.

According to a further example embodiment, the physical coin or note 100 and the unique NFT associated with the physical coin are convertible to a digital coin token. Upon conversion, the NFT associated with the physical coin or note 100 is destroyed or disabled.

According to a further example embodiment, the digital coin token is convertible to the physical coin or note 100 and the unique NFT associated with the coin. Upon conversion, the digital coin token is destroyed, disabled or deleted.

In some embodiments, the at least one core layer of the physical coin or note 100 is made of Nickel, Aluminum, or any other metal with an underplating of Nickel. At least one surface of the at least one core layer is provided with a raised surface portraying artwork (such as on traditional coins). The artwork is generated prior to the at least one inner layer covering the at least one core layer. After the at least one inner layer covers the generated artwork on the at least one core layer, the at least one inner layer and the at least one core layer are embedded in a solid and clear acrylic that takes on the shape of a coin. However, in some embodiments, the physical coin or note 100 need not be provided in the shape of a traditional coin.

In some embodiments, an identifying text or QR code (or equivalent thereof) is embedded within the outer shell of the physical coin or note 100. In some embodiments, the identifying text or QR code is embedded in close proximity to an edge of the physical coin or note 100, or on the edge of the physical coin or note 100 and facing outward along the edge such that this identifying information is not visible on either face (heads or tails) of the physical coin or note 100.

In some embodiments, the RFID tag 9 including the NFT-encrypted chip is embedded in an encasement such as the acrylic encasing of the outer shell of the physical coin or note 100. The chip encasement can be molded with artwork on one or both faces (sides) of the physical coin or note 100, similar to how a traditional metal coin has raised artwork on both faces (sides). Layers of one or more precious metals, such as gold, silver, or platinum, can then be overlaid on top of the artwork. Then the one or more precious metal layers and molded artwork are encased in an acrylic material to form the physical coin or note 100.

In some embodiments, the thin layer of one or more precious metals is layered on top of both sides of the RFID tag 9 and then encased in acrylic in coin form, or in another tangible shape or form different from a traditional coin. Optionally, the coin or note 100 includes art designs, text, ID, a QR code, on one or more surfaces of the thin layer of one or more precious metals.

The Aurum® note has the approximate form factor of conventional paper currency, but it functions as a modern vehicle for gold investment. Each Aurum® note contains a precise thin microlayer of 24 karat gold protected by additional thin layers of durable polymer. The Aurum® note is sometimes referred to as “goldback.” This technology is used to create a way to physically own gold that is flexible, durable and easy to store. According to one embodiment of the instant solution, the Aurum® note is tied to a cryptocurrency to establish a stablecoin asset. In some embodiments, the Aurum® note is equipped with an embedded RFID chip including the NFT-encrypted chip. In some embodiments, the coin or note 100 is an alternative physical asset to use in place of the Aurum® note. In some embodiments, gold, silver, or platinum may be used to manufacture the Aurum® note or its equivalent. The Aurum® note has all of the accompanying features of the coin or note 100, such as the RFID chip and NFT, etc., and it is tied to the stablecoin asset and used interchangeably with the coin or note 100 physical asset. The conversion rate of physical asset to stablecoin asset is correlated with the quantity of precious metals contained within the physical asset, such as the coin or note 100, or the Aurum® note. The coin or note 100 as well as the Aurum® note each include a very small quantity of the precious metal such, as, for example, 1/100^{th} of an ounce, or 1/1000^{th} of an ounce, or 1/5000^{th} of an ounce, for example.

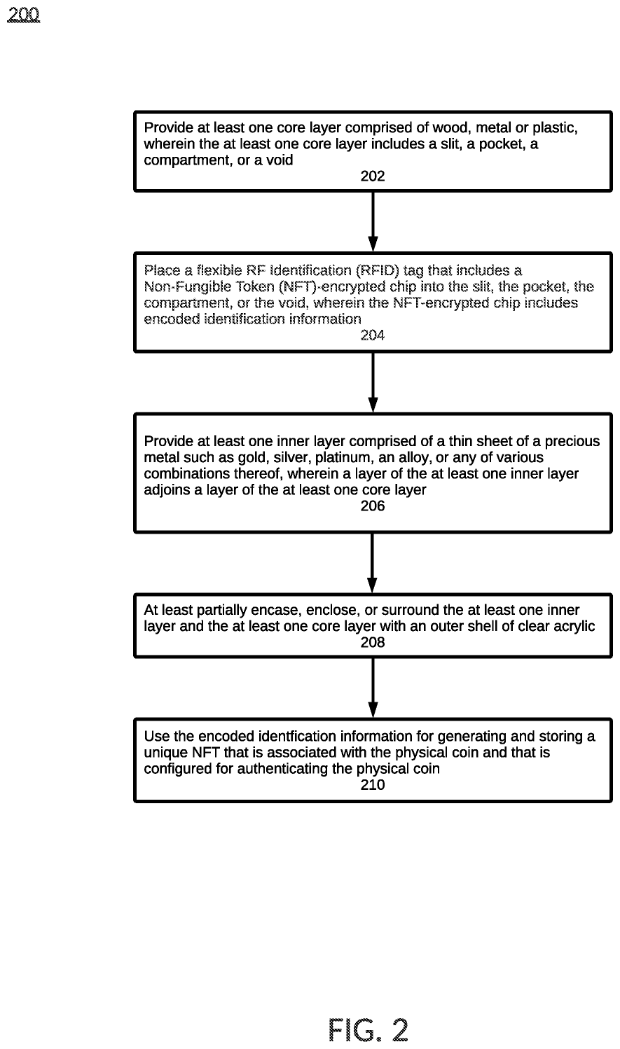

FIG. 2 illustrates a flow diagram 200 of a method for providing a cryptocurrency stablecoin asset, according to example embodiments. The method includes providing at least one core layer comprised of wood, metal, or plastic, the at least one core layer including a slit, pocket, compartment or void (block 202); placing a flexible RF Identification (RFID) tag that includes a Non-Fungible Token (NFT)-encrypted chip into the slit, pocket, compartment or void, wherein the NFT-encrypted chip includes encoded identification information (block 204); providing at least one inner layer comprised of a thin sheet of a precious metal such as silver, gold, platinum, or any of various combinations thereof, wherein a layer of the at least one inner layer adjoins a layer of the at least one core layer (block 206); at least partially encasing, enclosing or surrounding the at least one inner layer and the at least one core layer with an outer shell of clear acrylic (block 208); and using the encoded identification information for generating and storing a unique NFT that is associated with the physical coin and configured for authenticating the physical coin (block 210).

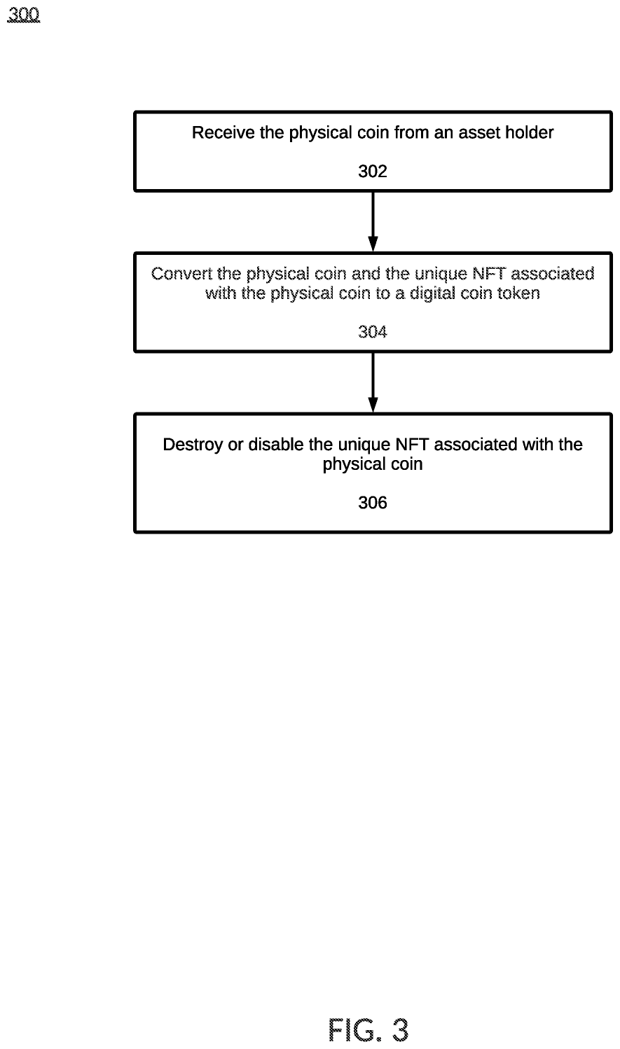

FIG. 3 illustrates a flow diagram 300 of a method for converting the cryptocurrency stablecoin asset to a digital coin token, according to a further set of embodiments. The method includes a custodian or originator company, or agent thereof, receiving the physical coin or note 100 (FIG. 1) from an asset holder (FIG. 3, block 302). The custodian or originator company is an entity which previously provided the physical coin or note 100 to the asset holder, and/or authorized an issuance of the physical coin or note 100. The physical coin and the unique NFT associated with the physical coin are converted to a digital coin token (block 304). Upon conversion, the NFT associated with the physical coin is destroyed or disabled (block 306). According to some embodiments, a network of physical branch locations and automated teller machines (ATMs) are employed to perform the method of FIG. 3. In some embodiments, the digital coin token and the physical coin or note 100 (FIG. 1) are usable in financial transactions in the same manner that other cryptocurrencies, such as bitcoin, are usable via a debit card, wherein the cryptocurrency is converted to an appropriate fiat currency at a point-of-sale. A given asset exists in either the digital coin token form or the physical coin or note 100 form, but this asset never exists simultaneously in both the digital coin token form and the physical coin or note 100 form.

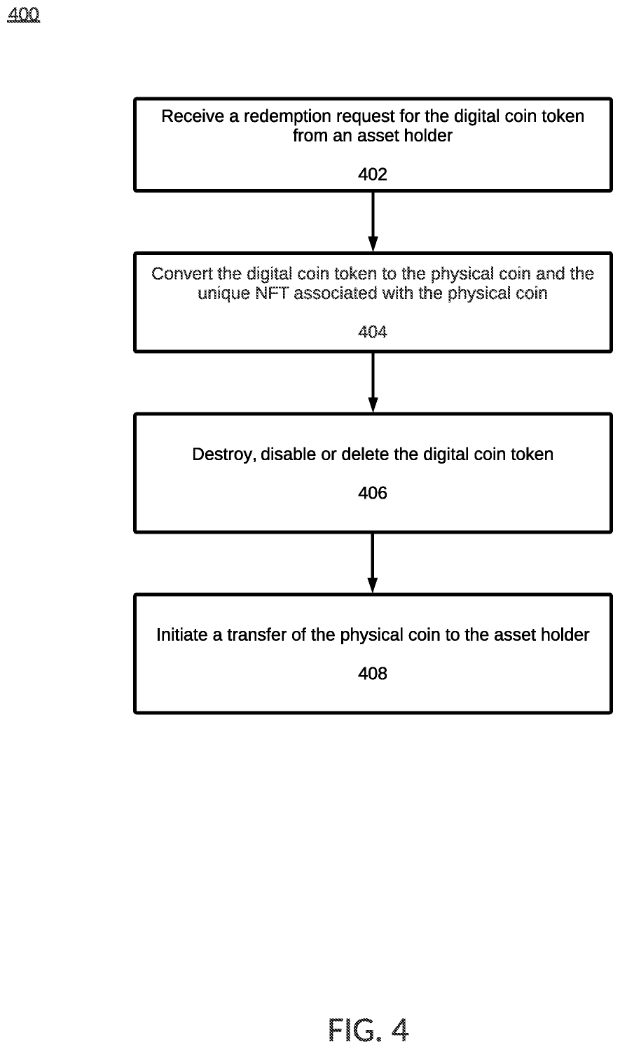

FIG. 4 illustrates a flow diagram 400 of a method for converting a digital coin token to the cryptocurrency stablecoin asset, according to a further set of embodiments. The method includes the custodian or originator company, or agent thereof, receiving a redemption request for the digital coin token from an asset holder (FIG. 4, block 402). The digital coin token is converted to the physical coin or note 100 (FIG. 1) and the unique NFT associated with the physical coin (FIG. 4, block 404). Upon conversion, the digital coin token is destroyed, disabled or deleted (block 406). The custodian or originator company, or agent thereof, initiates a transfer of the physical coin or note 100 (FIG. 1) to the asset holder (FIG. 4, block 408).

According to some embodiments, a network of physical branch locations and automated teller machines (ATMs) are employed to perform the method of FIG. 4. In some embodiments, the digital coin token and the physical coin or note 100 (FIG. 1) are usable in financial transactions in the same manner that other cryptocurrencies, such as bitcoin, are usable via a debit card, wherein the cryptocurrency is converted to an appropriate fiat currency at a point-of-sale. A given asset exists in either the digital coin token form or the physical coin or note 100 form, but this asset never exists simultaneously in both the digital coin token form and the physical coin or note 100 form. In some embodiments, the network of physical branches and ATMs include RFID/NFC bulk reader technology to verify and record conversion deposits of the physical assets (i.e., the physical coin or note 100) when customers initiate the process of converting the physical assets into cryptocurrency digital coin tokens. The resulting cryptocurrency coins in the conversion exchange can be minted at a point-of-sale terminal and deposited into a customer's account/wallet.

In some embodiments, small denominations/quantities of gold, silver, precious metals, and alloys, in whatever form, are provided to back digital cryptocurrency (stablecoin). One purpose of this feature is to cover all possible forms that achieve the feature of small, transactable denominations/quantities.

According to some embodiments, a check (such as a bank check) has encoded on it information for a specific amount of cryptocurrency asset which can be transferred and credited to a destination cryptocurrency wallet upon passcode identification of some kind, including optional ID verification. The encoded information is an encrypted smart contract that has been programmed to release a specific amount of cryptocurrency asset from a specific source cryptocurrency wallet to the destination cryptocurrency wallet. The medium of this check may be a paper document, comparable to a standard bank check, with an encrypted RFID chip embedded within the check, or with an encrypted RFID chip provided in sticker form and adhered to the check. The RFID chip is programmed with the herein-described smart contract.

The methods of FIGS. 2-4 are advantageous because they enable asset holders to easily and conveniently convert spendable digital cryptocurrency assets into a historically and reliable stable physical counterpart, such as gold, silver, or platinum, in a quantity that is practical for the average investor, and that is also practical for everyday transactions. The instant solution also allows asset holders to easily redeem the stable physical counterpart in exchange for a digital cryptocurrency asset. Likewise, the methods of FIGS. 2-4 provide the ability to engage in trustless financial transactions. The RFID tag 9 (FIG. 1) including the NFT-encrypted chip (FIG. 1) provides an excellent verification method. Asset holders are able to hold their wealth right in their own hands and view their wealth in a physically tangible form, as opposed to trusting a third-party custodian with physical assets and accepting the word of the custodian that the asset is safely accounted for in a secure vault.

According to some embodiments, the methods of FIGS. 2-4 define a protocol that is only modifiable by the mutual consent of both the custodian or originator company and at least the asset holders of approximately 75% (or 66% or 80%) of the then-present cryptocurrency digital coin token and physical coin or note 100 (FIG. 1) asset supply. In some embodiments, one physical coin or note 100 (FIG. 1) equals one cryptocurrency digital coin token. If either the custodian/originator company or the holders of approximately 75% (or 66% or 80%) of the then-present asset supply vote to approve a proposed modification of the protocol, then the proposed modification will occur. If only either more than 25% of asset holders or the originating company reject a proposed change, then a change shall not be made. These percentages are provided solely as illustrative examples, as other percentages may be utilized upon launch of the physical coin or note 100. There shall be a minimum amount of time before a rejected proposal can be submitted again. Protocol modifications may be proposed by either the custodian/originator company or any single asset holder of at least 10% (or 5%, or 25%) of the existing asset supply. Coalitions may be formed among a plurality of asset holders to meet this 10% (or 5%, or 25%) requirement. A set, limited number of proposed modifications may be presented by each 10% (or 5%, or 25%) asset holder or coalition once every so often (in some embodiments, once at the beginning of every quarter, or 4 times per year).

In some embodiments, the thin sheet of precious metal comprising at least one inner layer of the physical coin or note 100 is used interchangeably with a gold and/or silver denomination based upon the content of precious metal or alloy in the at least one inner layer. The physical coin or note 100 can be converted into an analogous quantity of digital cryptocurrency coin.

In some embodiments, digital coin tokens are sold at will by the custodian or originator company. The custodian or originator company will use proceeds received from one or more asset holders of the digital coin tokens to purchase a correlated amount of bullion and use the bullion to manufacture a corresponding amount of physical coins (such as the physical coin or note 100), prior to taking an optional profit from any remaining proceeds. The manufacture of the corresponding amount of physical coins can be verified using data on one or more NFT-encrypted chips associated with the new physical assets created.

In some embodiments, ownership of physical assets (the physical coin or note 100, FIG. 1) is verified and recorded via a registering and/or sending of the NFT whose ID data is stored in the the RFID tag 9 (FIG. 1). The ID data may be stored in a server, database, or other computer-readable storage medium. The ID data may be registered and/or sent to an account/wallet that has been issued or set up by the custodian or originator company, or agent thereof, specifically for storing and transacting with physical coins (such as the physical coin or note 100, FIG. 1) and the digital coin tokens. In some embodiments, the account/wallet is established according to Know Your Customer requirements. Alternatively, for asset holders that prefer to maintain their anonymity, such asset holders may register/send the ID data of the NFT to a conventional digital or physical crypto wallet. The RFID tag 9 can be registered/sent to a new account/wallet by any individual who possesses the physical coin or note 100 asset by interfacing with the ID data stored within the RFID tag 9.

Cryptocurrency has historically used a decentralized ledger blockchain system for recording transactions. In a decentralized ledger blockchain, transactions are generally irreversible. According to some embodiments, a decentralized ledger blockchain is provided with a two-party transaction reversal capability wherein the transaction is reversed if both the sender of a particular transaction and the custodian or originator company that owns the rights to the technology approve the reversal. The sender of a transaction may set in-person a custom transaction limit that triggers this reversal, and/or that triggers a hold on the transaction. In some embodiments, this reversal ability can be provided for the first 48, 72, or 96 hours (or other customizable time period) after the transaction has been initiated. During the time period where reversal ability is provided, a hold may be placed on all sent assets on the end of an asset receiver for the transaction. In some embodiments, the reversal ability is not provided when an asset sender verifies in person at a branch location, or verifies via an ATM videoconference session, by displaying an appropriate government-issued photo ID to verify that a particular transaction is valid and authorized.

A decentralized database is a distributed storage system which includes multiple nodes that communicate with each other. A blockchain is an example of a decentralized database, which includes an append-only immutable data structure (i.e. a distributed ledger) capable of maintaining records between untrusted parties. The untrusted parties are referred to herein as peers, nodes or peer nodes. Each peer maintains a copy of the database records and no single peer can modify the database records without a consensus being reached among the distributed peers. For example, the peers may execute a consensus protocol to validate blockchain storage entries, group the storage entries into blocks, and build a hash chain via the blocks. This process forms the ledger by ordering the storage entries, as is necessary, for consistency. In a public or permissionless blockchain, anyone can participate without a specific identity. Public blockchains can involve crypto-currencies and use consensus based on various protocols such as proof of work (PoW). Conversely, a permissioned blockchain database can secure interactions among a group of entities, which share a common goal, but which do not or cannot fully trust one another, such as businesses that exchange funds, goods, information, and the like. The instant solution can function in a permissioned and/or a permissionless blockchain setting.

Smart contracts are trusted distributed applications, which leverage tamper-proof properties of the shared or distributed ledger (which may be in the form of a blockchain) and an underlying agreement between member nodes, which is referred to as an endorsement or endorsement policy. In general, blockchain entries are “endorsed” before being committed to the blockchain while entries, which are not endorsed are disregarded. A typical endorsement policy allows smart contract executable code to specify endorsers for an entry in the form of a set of peer nodes that are necessary for endorsement. When a client sends the entry to the peers specified in the endorsement policy, the entry is executed to validate the entry. After validation, the entries enter an ordering phase in which a consensus protocol is used to produce an ordered sequence of endorsed entries grouped into blocks.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node, which submits an entry-invocation to an endorser (e.g., peer), and broadcasts entry-proposals to an ordering service (e.g., ordering node). Another type of node is a peer node, which can receive client submitted entries, commit the entries and maintain a state and a copy of the ledger of blockchain entries. Peers can also have the role of an endorser. An ordering-service-node or orderer is a node running the communication service for all nodes, and which implements a delivery guarantee, such as a broadcast to each of the peer nodes in the system when committing entries and modifying a world state of the blockchain. The world state can constitute the initial blockchain entry, which normally includes control and setup information.

A ledger is a sequenced, tamper-resistant record of all state transitions of a blockchain. State transitions may result from smart contract executable code invocations (i.e., entries) submitted by participating parties (e.g., client nodes, ordering nodes, endorser nodes, peer nodes, etc.). An entry may result in a set of asset key-value pairs being committed to the ledger as one or more operands, such as creates, updates, deletes, and the like. The ledger includes a blockchain (also referred to as a chain), which is used to store an immutable, sequenced record in blocks. The ledger also includes a state database, which maintains a current state of the blockchain. There is typically one ledger per channel. Each peer node maintains a copy of the ledger for each channel of which they are a member.

A chain is an entry log structured as hash-linked blocks, and each block contains a sequence of N entries where N is equal to or greater than one. The block header includes a hash of the blocks' entries, as well as a hash of the prior block's header. In this way, all entries on the ledger may be sequenced and cryptographically linked together. Accordingly, it is not possible to tamper with the ledger data without breaking the hash links. A hash of a most recently added blockchain block represents every entry on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain entry log. Since the current state represents the latest key values known to a channel, it is sometimes referred to as a world state. Smart contract executable code invocations execute entries against the current state data of the ledger. To make these smart contract executable code interactions efficient, the latest values of the keys may be stored in a state database. The state database may be simply an indexed view into the chain's entry log and can therefore be regenerated from the chain at any time. The state database may automatically be recovered (or generated if needed) upon peer node startup, and before entries are accepted.

A blockchain is different from a traditional database in that the blockchain is not a central storage but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like.

In some embodiments, a system to back-up and redeploy copies of entire cryptocurrency networks is provided. This system is configured to back up and redeploy information stored in the nodes of the decentralized blockchain structure, including back-ups of all records of all transactions within these cryptocurrency networks in real-time, stored centrally in multiple database facilities. The use of multiple database facilities addresses scenarios where catastrophic events that involve mass internet and/or power outages, EMP's, etc., may occur.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

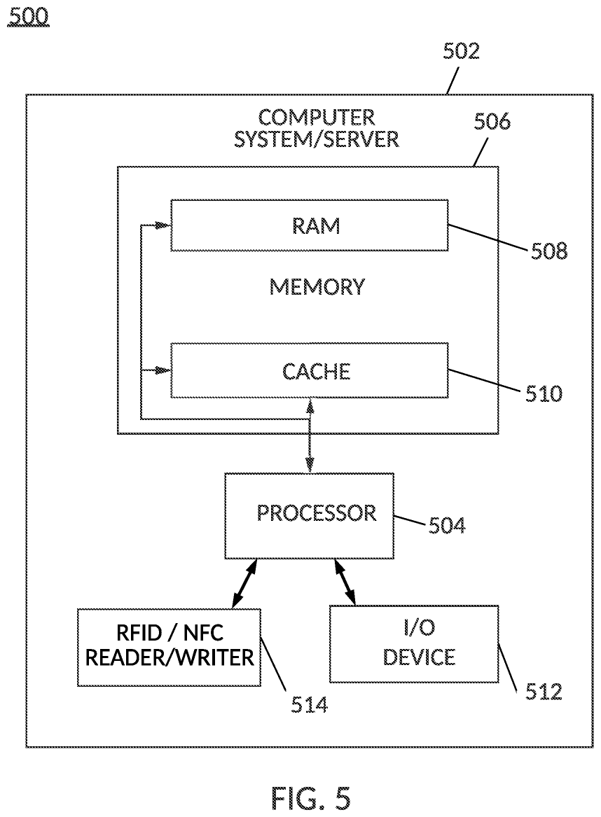

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 5 illustrates an example computer system architecture 700, which may be used to implement any of the methods previously discussed in connection with FIGS. 2-4.

FIG. 5 is not intended to suggest any limitation as to the scope of use or functionality of embodiments of the application described herein. Regardless, the computing node 500 is capable of being implemented and/or performing any of the functionality set forth hereinabove, including but not limited to blockchain functionality.

In computing node 500 there is a computer system/server 502, which is operational with numerous other general purpose or special purpose computing system environments or configurations. Examples of well-known computing systems, environments, and/or configurations that may be suitable for use with computer system/server 502 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 502 in cloud computing node 500 is shown in the form of a general-purpose computing device. The components of computer system/server 502 may include, but are not limited to, one or more processors or processing units 504, a system memory 506, and a bus that couples various system components including system memory 506 to processor 504.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 502 typically includes a variety of computer system readable media. Such media may be any available media that is accessible by computer system/server 502, and it includes both volatile and non-volatile media, removable and non-removable media. System memory 506, in one example, implements the flow diagrams of the other figures. The system memory 506 can include computer system readable media in the form of volatile memory, such as random-access memory (RAM) 508 and/or cache memory 510. Computer system/server 502 may further include other removable/non-removable, volatile/non-volatile computer system storage media. By way of example only, memory 506 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 506 may include at least one program product having a set (e.g., at least one) of program modules that are configured to carry out the functions of various embodiments of the application.

Program/utility, having a set (at least one) of program modules, may be stored in memory 506 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 502 may also communicate with one or more external devices via an I/O device 512 (such as an I/O adapter), which may include a keyboard, a pointing device, a display, a voice recognition module, etc., one or more devices that enable a user to interact with computer system/server 502, and/or any devices (e.g., network card, modem, etc.) that enable computer system/server 502 to communicate with one or more other computing devices. Such communication can occur via I/O interfaces of the device 512.

Computer system/server 502 may communicate with the RFID tag 9 and NFT-encrypted chip of the coin or note 100 (FIG. 1) via an RFID/NFC reader/writer 514 (FIG. 5). Still yet, computer system/server 502 can communicate with one or more networks such as a local area network (LAN), a general wide area network (WAN), and/or a public network (e.g., the Internet) via a network adapter. As depicted, device 512 communicates with the other components of computer system/server 502 via a bus. It should be understood that although not shown, other hardware and/or software components could be used in conjunction with computer system/server 502. Examples, include, but are not limited to: microcode, device drivers, redundant processing units, external disk drive arrays, RAID systems, tape drives, and data archival storage systems, etc.

The flow diagrams depicted herein, such as FIGS. 2-4, are separate examples but may be the same or different embodiments. Any of the operations in one flow diagram could be adopted and shared with another flow diagram. No example operation is intended to limit the subject matter of any embodiment or corresponding claim.

It is important to note that all the flow diagrams and corresponding processes derived from FIGS. 2-4, may be part of a same process or may share sub-processes with one another, thus making the diagrams combinable into a single preferred embodiment that does not require any one specific operation but which performs certain operations from one example process and from one or more additional processes. All the example processes are related to the same physical system and can be used separately or interchangeably.

Although an exemplary embodiment of at least one of a device, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations that when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A physical asset comprising at least one precious-metal provided in a small quantity in the range of 1/25th of an ounce to 1/10,000th of an ounce, wherein the physical asset is associated with a digital asset.

2. The physical asset of claim 1, wherein the digital asset is cryptocurrency stablecoin.

3. A physical coin or note configured to provide a cryptocurrency stablecoin asset, the coin or note comprising:
at least one core layer comprised of wood, metal, plastic, or any of various combinations thereof;
at least one inner layer comprised of a thin sheet of a precious metal; and
an outer shell comprised of a transparent material;
wherein a layer of the at least one inner layer adjoins a layer of the at least one core layer;
wherein the at least one core layer includes a slit, a pocket, a compartment or a void into which a flexible RF Identification (RFID) tag is placed; and
wherein the RFID tag includes a Non-Fungible Token (NFT)-encrypted chip.

4. The physical coin or note of claim 3, wherein the NFT-encrypted chip includes encoded identification information for generating and storing a unique NFT that is associated with the coin or note and configured for authenticating the coin.

5. The physical coin or note of claim 3, wherein at least a portion of the outer shell is comprised of a clear acrylic material.

6. The physical coin or note of claim 3, wherein at least a portion of the precious metal comprises gold, silver, platinum, palladium, or any of various combinations thereof.

7. The physical coin or note of claim 3, wherein the coin or note is convertible to a digital coin token such that, upon conversion, the unique NFT associated with the coin or note is destroyed, disabled, or deleted.

8. The physical coin of claim 3, wherein a digital coin token is convertible to the coin or note and the unique NFT associated with the coin or note such that, upon conversion, the digital coin token is destroyed, disabled, or deleted.

9. The physical coin or note of claim 3, wherein the at least one core layer is made of Nickel, Aluminum, or any other metal, with an underplating of Nickel.

10. The physical coin or note of claim 3, wherein at least one surface of the at least one core layer is provided with a raised surface portraying artwork.

11. The physical coin or note of claim 10, wherein the raised surface portraying artwork is provided prior to covering the at least one core layer with the at least one inner layer.

12. The physical coin or note of claim 11 wherein, after the at least one inner layer covers the raised surface portraying artwork on the at least one core layer, the at least one inner layer and the at least one core layer are embedded in a solid and clear acrylic that takes on the shape of a coin or note.

13. The physical coin or note of claim 3, wherein the at least one inner layer comprises a very small quantity of precious metal in an approximate range of 1/100^{th} of an ounce to 1/5000^{th} of an ounce.

14. The physical coin or note of claim 3, further comprising embedding an identifying text or a quick response (QR) code within the outer shell of the physical coin or note, or in close proximity to an edge of the physical coin or note, or on the edge of the physical coin or note and facing outward along the edge.

15. A method comprising:
associating a digital asset with a physical asset that includes at least one precious-metal, and
providing the at least one precious metal in a small quantity in the range of 1/25th of an ounce to 1/10,000th of an ounce.

16. The method of claim 15, further comprising providing the digital asset as a cryptocurrency stablecoin.

17. A method for providing a cryptocurrency stablecoin asset, the method comprising:
providing at least one core layer comprised of wood, metal, plastic, or any of various combinations thereof; wherein the at least one core layer includes a slit, a pocket, a compartment or a void;
placing a flexible RF Identification (RFID) tag into the slit, the pocket, the compartment, or the void; wherein the RFID tag includes a Non-Fungible Token (NFT)-encrypted chip;
providing at least one inner layer comprised of a thin sheet of a precious metal; and
providing an outer shell comprised of a transparent material;
wherein a layer of the at least one inner layer adjoins a layer of the at least one core layer; and
at least partially enclosing or surrounding the at least one core layer and the at least one inner layer with the outer shell to form a physical coin or note.

18. The method of claim 17, further comprising storing encoded identification information on the NFT-encrypted chip, the encoded identification information configured for generating and storing a unique NFT that is associated with the coin or note and configured for authenticating the coin or note.

19. The method of claim 18, further comprising providing a network of physical branch locations and automated teller machines configured to authenticate the coin or note.

20. The method of claim 19, further comprising encoding a bank check with information specifying an amount of cryptocurrency asset which is to be transferred and credited to a destination cryptocurrency wallet.

21. The method of claim 18, further comprising providing at least a portion of the outer shell using a clear acrylic material.

22. The method of claim 18, further comprising providing at least a portion of the precious metal using gold, silver, platinum, palladium, or any of various combinations thereof.

23. The method of claim 18, further comprising converting the coin or note to a digital coin token, and destroying, disabling, or deleting the unique NFT associated with the coin or note.

24. The method of claim 18, further comprising converting a digital coin token to the coin or note and the unique NFT associated with the coin or note, and destroying, disabling, or deleting the digital coin token.

25. The method of claim 17, further comprising providing the at least one core layer using Nickel, Aluminum, or any other metal, with an underplating of Nickel.

26. The method of claim 17, further comprising providing at least one surface of the at least one core layer with a raised surface portraying artwork.

27. The method of claim 26, further comprising providing the raised surface portraying artwork prior to covering the at least one core layer with the at least one inner layer.

28. The method of claim 27 wherein, after the at least one inner layer covers the raised surface portraying artwork on the at least one core layer, the at least one inner layer and the at least one core layer are embedded in a solid and clear acrylic that takes on the shape of a coin or note.

29. The method of claim 17, further comprising providing the at least one inner layer using a very small quantity of precious metal in an approximate range of 1/100^{th} of an ounce to 1/5000^{th} of an ounce.

30. The method of claim 23, further comprising:
defining a protocol for the cryptocurrency stablecoin that is only modifiable by mutual consent of both:
(i) a custodian company for the cryptocurrency stablecoin, and
(ii) one or more asset holders of approximately 75% (or 66% or 80%) of: (a) a current asset supply of one or more digital coin tokens, including the digital coin token, plus (b) a current asset supply of one or more coins or notes, including the coin or note;
wherein, when either the custodian company or the one or more asset holders of approximately 75% (or 66% or 80%) vote to approve a proposed modification of the protocol, then the proposed modification will occur; and
wherein, when only either more than 25% of the one or more asset holders or the custodian company reject the proposed modification, then the proposed modification is not made.

31. The method of claim 18, further comprising providing a decentralized ledger blockchain configured to reverse a transaction of the cryptocurrency stablecoin asset, wherein the transaction is reversed if both a sender of the transaction and a custodian company that is a custodian for the cryptocurrency stablecoin asset approve a reversal of the transaction;
wherein the reversal is triggered in response to the sender establishing a custom transaction limit that triggers the reversal;
wherein the reversal is configured for being performed only within a reversal time period comprising 12, 24, 48, 72, or 96 hours after the transaction has been initiated;
wherein, during the reversal time period, a hold is placed at an asset receiver end of the transaction;
wherein the reversal is not provided when an asset sender verifies in person at a branch location, or verifies via an ATM videoconference session, by displaying an appropriate government-issued photo ID to verify that the transaction is valid and authorized.

32. The method of claim 31, further comprising providing the decentralized ledger blockchain as a decentralized database including a distributed storage system comprising multiple nodes that communicate with each other; wherein the decentralized database includes an append-only immutable data structure capable of maintaining records of the transaction between a plurality of untrusted parties, wherein the plurality of untrusted parties each comprise one or more peer nodes, such that each peer node maintains a copy of the records, and no single peer node is configured to modify the records without a consensus being reached among each peer node.

33. The method of claim 32, further comprising providing a back-up system to back-up and redeploy a copy of a cryptocurrency network for maintaining the cryptocurrency stablecoin asset, by configuring the back-up system to back up and redeploy stored information received from a plurality of nodes of the decentralized ledger blockchain, wherein the stored information includes back-ups of a plurality of records of a plurality of transactions within the cryptocurrency network in real-time, and wherein the stored information is stored in a plurality of database facilities.

34. A physical asset comprising at least one precious-metal provided in a small quantity in the range of 1/25th of an ounce to 1/10,000th of an ounce, wherein the physical asset is associated with a digital asset comprising a cryptocurrency stablecoin, wherein the physical asset comprises at least one of an Aurum® note, a Goldback note, a Silverback note, a Platinumback note, a Palladiumback note, or any of various combinations thereof.

35. The physical asset of claim 34, wherein the physical asset further comprises a flexible RF Identification (RFID) tag including a Non-Fungible Token (NFT)-encrypted chip.

36. The physical asset of claim 34, wherein the NFT-encrypted chip includes encoded identification information for generating and storing a unique NFT that is associated with the physical asset and configured for authenticating the physical asset.

37. The physical asset of 34, further including an outer shell, wherein at least a portion of the outer shell is comprised of a clear acrylic material.

38. The physical asset of claim 36, wherein the physical asset is convertible to a digital token such that, upon conversion, the unique NFT associated with the physical asset is destroyed, disabled, or deleted.

39. The physical asset of claim 36, wherein a digital token is convertible to the physical asset and the unique NFT associated with the coin or note such that, upon conversion, the digital coin token is destroyed, disabled, or deleted.

40. The physical asset of claim 34, wherein at least one surface of the physical asset is provided with a raised surface portraying artwork.

41. The physical asset of claim 40, wherein the raised surface portraying artwork is embedded in a solid and clear acrylic that takes on the shape of a note of currency.

42. The physical asset of claim 34, further comprising at least one inner layer including a very small quantity of precious metal in an approximate range of 1/100^{th} of an ounce to 1/5000^{th} of an ounce.
